(19) United States
(12) Patent Application Publication
(10) Pub. No.: US 2007/0284908 A1
(43) Pub. Date: Dec. 13, 2007

(54) GOLF CAR SEAT BACK AND SWEATER BASKET SUPPORT TUBES

(75) Inventors: Landon Ball, North Augusta, SC (US); Anthony J. Sanville, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/381,876

(22) Filed: May 5, 2006

(51) Int. Cl. B62D 25/06; B60N 2/00

(52) U.S. Cl. 296/104; 296/63

(57) ABSTRACT

A vehicle is provided including a vehicle structure, a seat back, and a support member. The support member can include a piece of metal tubing. The piece of metal tubing can have a plurality of engagement portions. A first engagement portion can be coupled to the vehicle structure. A second said engagement portion can be coupled to the seat back. A third engagement portion can be coupled to a sweater basket, and a fourth engagement portion can be coupled to a rear canopy support strut.

### FIELD

The present disclosure relates to golf cars and to a seat and sweater basket support members for a golf car.

### BACKGROUND

The statements in this section merely provide background information related to the present disclosure and may not constitute prior art.

Golf cars provide transportation for golfers around a golf course. A golf car must also securely carry a golf bag in a location for convenient access throughout a round of golf. Many golf cars are equipped with a seat back support member. The seat back support member can be coupled to both a seat back and a structural member of the golf car. These support members are often made of complicated and expensive castings.

### SUMMARY

According to the present disclosure, a vehicle is provided including a vehicle structure, a seat back, and a support member. The support member can include a piece of metal tubing. The piece of metal tubing can have a plurality of engagement portions. A first engagement portion can be coupled to the vehicle structure. A second engagement portion can be coupled to the seat back.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car including the seat back support assembly of the present disclosure;

FIG. 2 is an exploded perspective view of a rear portion of the golf car of FIG. 1; and

FIG. 3 is a perspective view of the support member of the golf car of FIG. 1.

### DETAILED DESCRIPTION OF THE VARIOUS EMBODIMENTS

The following description of various embodiments is merely exemplary in nature and is in no way intended to limit the present disclosure, application, or uses.

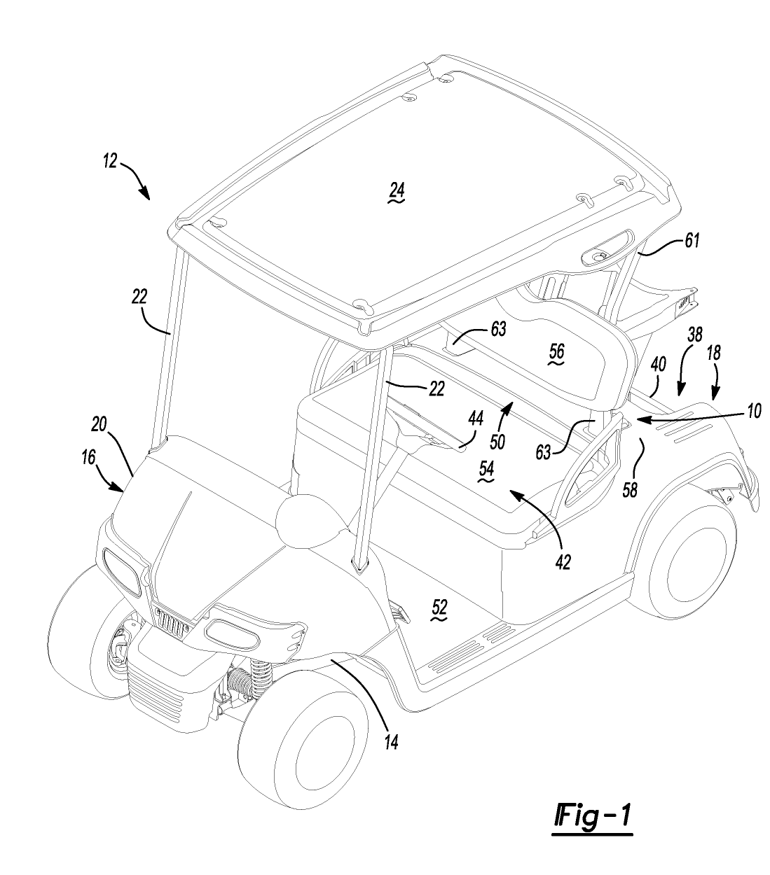

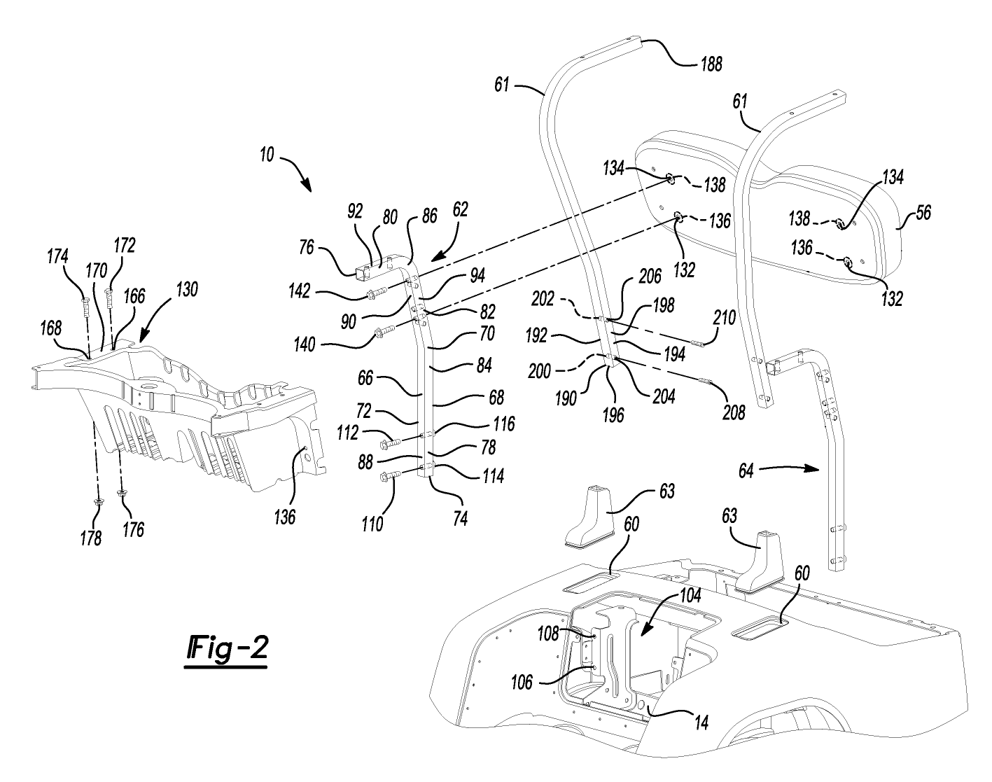

With initial reference to FIGS. 1 and 2, a seat back support assembly constructed in accordance to the present disclosure is shown and identified generally at reference 10. The seat back support assembly 10 is illustrated operably connected to an exemplary golf car 12. It is appreciated that the golf car 12 is merely exemplary and that the seat back support assembly 10 can be adapted for use with other golf car configurations. Furthermore, the seat back support assembly 10 described herein is not limited for use with golf cars and can also be used with other vehicles such as, but not limited to, utility vehicles, lawnmowers, and other turf care vehicles.

The golf car 12 can include a frame 14 having a front portion 16 and a rear portion 18 mounted thereon. The front portion 16 of golf car 12 can include a front body assembly 20. A pair of front struts 22 can be coupled to front portion 16 and a front portion of a roof canopy 24.

The rear portion 18 can include a rear body assembly 38 generally covering a rear portion of frame 14. The rear body assembly 38 can include a golf bag storage area 40 and a passenger seating area 42. The passenger seating area 42 can include a steering wheel 44, accelerator and brake pedals (not shown), a seat 50, and a floor portion 52. The seat 50 can include a seat bottom 54 and a seat back 56. The seat back 56 can be coupled to the golf car 12 and supported by seat back support assembly 10, discussed in greater detail below. The rear body assembly can further include an upper surface 58 located between the golf bag storage area 22 and passenger seating area 42. Upper surface 58 can include apertures 60 therein, best shown in FIG. 2. Seat back support assembly 10 can extend into apertures 60 and be mounted to frame 14. Covers 63 can be coupled to apertures 60, generally concealing the apertures 60 from the exterior of golf car 12. A pair of rear struts 61 can be coupled to seat back support assembly 10 and support a rear portion of roof canopy 24.

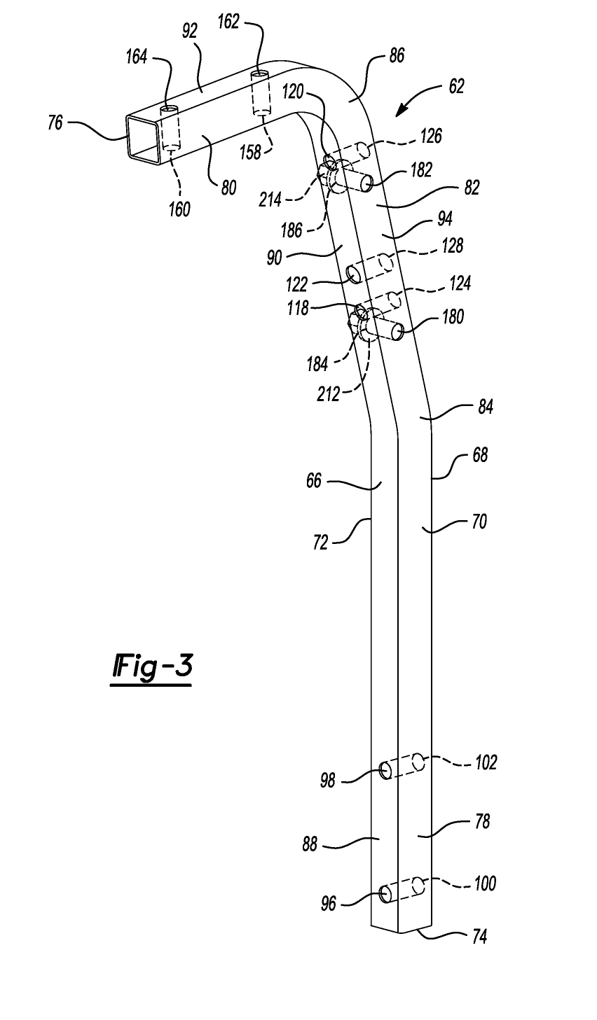

Seat back support assembly 10 can include first and second support members 62, 64. Support members 62, 64 can be generally similar to one another. As such, only support member 62 will be described in detail for simplicity. With additional reference to FIG. 3, support member 62 can be formed from a single piece of generally rectangular or round tubing. Support member 62 can be generally hollow and have four outer surfaces 66, 68, 70, 72. Support member 62 can further include first and second ends 74, 76. The first end 74 can include a first body portion 78. The second end 76 can include a second body portion 80. A third body portion 82 can be disposed between the first and second body portions 78, 80. The third body portion 82 can be generally parallel to seat back 56. The first body portion 78 can extend from a first end 84 of third body portion 82 at an angle in a direction generally outwardly from seat back 56. The second body portion 80 can extend generally perpendicular from a second end 86 of third body portion 82. The support member 62 can include engagement portions 88, 90, 92, 94 in the first, second and third body portions 78, 80, 82.

The first body portion 78 can include a first engagement portion 88. The first engagement portion 88 can include apertures 96, 98 extending through surface 66 and apertures 100, 102 extending through surface 68 and generally aligned with apertures 96, 98. The first body portion 78 can extend into aperture 60 in upper surface 58 of rear body assembly 38. The first engagement portion 88 can generally abut a flange 104 (shown in FIG. 2) extending from frame 14 at surface 66. The flange 104 can include apertures 106, 108 for coupling frame 14 to first engagement portion 88. Bolts 110, 112 can pass through apertures 96, 100, 106 and apertures 98, 102, 108, respectively. Nuts 114, 116 can be non-rotatably coupled to surface 68 at apertures 100, 102. Bolts 110, 112 can engage nuts 114, 116, thereby coupling flange 104 to first engagement portion 88.

The second engagement portion 90 can include apertures 118, 120, 122 formed in surface 66 and apertures 124, 126, 128 extending through surface 68 and generally aligned with apertures 118, 120, 122. Second engagement portion 90 can be coupled to seat back 56 and to a sweater basket 130. The seat back 56 can include apertures 132, 134 generally aligned with apertures 118, 124 and apertures 120, 126 for mounting second engagement portion 90 to seat back 56. Apertures 132, 134 can include threaded inserts 136, 138 therein. Bolts 140, 142 can pass through apertures 118, 124, 132 and 120, 126, 134, engaging threaded inserts 136, 138, thereby coupling support member 62 to seat back 56. The sweater basket 130 can include apertures 136 generally aligned with apertures 122, 128 for mounting second engagement portion 90 to sweater basket 130.

The third engagement portion 92 can include apertures 158, 160 formed in surface 66 and apertures 162, 164 extending through surface 68 and generally aligned with apertures 158, 160, respectively. Sweater basket 130 can include apertures 166, 168 extending through ledge 170. Bolts 172, 174 can extend through apertures 158, 162, 166 and apertures 160, 164, 168. Nuts 176, 178 can be coupled to a threaded end of bolts 172, 174, thereby coupling sweater basket 130 to third engagement portion 92. Nuts 176, 178 can be fixed to surface 66 of third engagement portion 92. This attachment may be accomplished through a welded coupling using weld nuts. Alternatively, a conventional nut can be used.

The fourth engagement portion 94 can include apertures 180, 182 formed in surface 70 and apertures 184, 186 extending through surface 72 and generally aligned with apertures 180, 182. The fourth engagement portion 94 can generally abut a rear strut 61. The rear strut 61 can include first and second ends 188, 190. The first end 188 can be coupled to a rear portion of roof canopy 24. The second end 190 can be coupled to and supported by support member 62. Rear strut 61 can have a generally rectangular cross-section with four (4) sides 192, 194, 196, 198. Side 192 can include apertures 200, 202 and side 194 can include apertures 204, 206 generally aligned with apertures 200, 202, respectively. Side 192 can be abutted against support member surface 70 and apertures 200, 202 can be generally aligned with apertures 180, 182. Bolts 208, 210 can extend through apertures 180, 184, 192, 204 and apertures 182, 186, 194, 206. Nuts 212, 214 (best shown in FIG. 3) can be coupled to a threaded end of bolts 208, 210, thereby coupling rear strut 61 to fourth engagement portion 94. Nuts 212, 214 can be fixed to surface 72 of fourth engagement portion 94. This attachment may be accomplished through a welded coupling using weld nuts. Alternatively, a conventional nut can be used.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A vehicle comprising:
a vehicle structure including a frame and a rear body member;
a seat back; and
a support member, said support member including a piece of metal tubing, said piece of metal tubing having a plurality of engagement portions, a first of said engagement portions extending through said rear body member and coupled to said frame and a second of said engagement portions coupled to said seat back.

2. The vehicle of claim 1, further comprising a basket coupled to said support member proximate said seat back, at least a portion of said support member disposed between said seat back and said basket.

3. The vehicle of claim 2, wherein said metal tubing includes a third engagement portion, said third engagement portion disposed at an angle relative to said second engagement portion wherein said third engagement portion is coupled to said basket.

4. The vehicle of claim 1, wherein said metal tubing further includes a third engagement portion, said third engagement portion coupled to a rear strut supporting a canopy.

5. The vehicle of claim 1, wherein a nut is coupled to said piece of metal tubing, said nut being generally aligned with an aperture in said first engagement portion, said aperture configured to receive a fastener.

6. The vehicle of claim 1, wherein said first engagement portion is generally disposed in a first plane and said second engagement portion is disposed in a second plane, said first plane angled outwardly from said second plane in a direction generally away from said seat back.

7. The vehicle of claim 1, wherein said metal tubing has a rectangular cross-section.

8. The vehicle of claim 1, wherein said entire support member is comprised of said metal tubing.

9. The vehicle of claim 1, wherein said support member is comprised of two generally identical pieces of metal tubing, said first piece coupled to a left side of said seat back and said second piece coupled to a right side of said seat back.

10. The vehicle of claim 1, wherein said vehicle is a golf car.

11. A golf car comprising:
a vehicle structure;
a seat back;
a support member formed from tubing, a first portion of said tubing generally abutting a seat back and coupled thereto, a second portion of said tubing coupled to said vehicle structure;
a canopy strut coupled to and supported by said tubing; and
a basket container coupled to said tubing, said first portion of said tubing disposed between said seat back and said basket.

12. The vehicle of claim 11, wherein said vehicle structure includes a frame and a rear body member, said support member extending through an aperture in said rear body member and coupled to said frame.

13. A golf car support comprising:
a generally tubular body having a generally rectangular cross-section, said generally tubular body having a plurality of apertures therethrough, a first of said apertures configured to provide coupling between said generally tubular body and a structural portion of a golf car, a second aperture configured to provide coupling between said generally tubular body and a golf car seat back.

14. The golf car support of claim 13, wherein said plurality of apertures includes a third aperture configured to provide coupling between said generally tubular body and a golf car basket.

15. The golf car support of claim 14, wherein said plurality of apertures includes a fourth aperture configured to provide coupling between said generally tubular body and a golf car canopy strut.

16. The golf car support of claim 13, wherein said generally tubular body includes at least one nut coupled thereto and generally aligned with an aperture therethrough.

17. The golf car support of claim 13, wherein said generally tubular body includes a first portion, a second portion, and a third portion, said second portion extending at an angle from a first end of said first portion in a direction generally away from a golf car seat, said third portion extending at an angle from a second end of said first portion in a direction generally away from the golf car seat.
